(19) United States
(12) Patent Application Publication
(10) Pub. No.: US 2010/0209549 A1
(43) Pub. Date: Aug. 19, 2010

(54) INSTANTIZER AND METHODS OF USING THE SAME

(76) Inventors: Lyle Quandt, Eau Claire, WI (US); James A. Coalson, Tuscola, TX (US); Dan Shields, Reedsburg, WI (US); Rick Field, Wonewoc, WI (US)

Correspondence Address: FOLEY & LARDNER LLP, 150 EAST GILMAN STREET, P.O. BOX 1497, MADISON, WI, 53701-1497, US

(21) Appl. No.: 12/698,469

(22) Filed: Feb. 2, 2010

Related U.S. Application Data
(60) Provisional application No. 61/152,319, filed on Feb. 13, 2009.

(51) Int. Cl. A23P 1/02; A23K 1/18; A23K 1/04; A23K 1/12

(52) U.S. Cl. 426/2; 426/285; 425/222

(57) ABSTRACT

The present technology relates to an apparatus and a method of producing instantized products. The method comprises using multiple agglomerators with various orifice/spinner arrangements as a component of an instantizer system. The use of the different agglomerators produces instant products with variable particle sizes as desired, which can handle the stress of packaging and handling.

### CROSS-REFERENCE TO RELATED APPLICATIONS

This application claims priority to U.S. Provisional Application No. 61/152,319, filed Feb. 13, 2009, the entire contents of which are hereby incorporated by reference in its entirety.

### TECHNICAL FIELD

The present technology relates to methods of processing food, animal feed and industrial products. In particular, the present technology relates to an apparatus and a method of producing instantized products.

### BACKGROUND

The following description is provided to assist the understanding of the reader. None of the information provided or references cited is admitted to be prior art to the present invention.

Instant food and feed products find a wide range of use in the consumer market. The term “instant” is normally used in the food industry to characterize products which are able to disperse quickly and dissolve in a specific liquid at any temperature, particularly at cold or ambient temperature, without leaving any residue or sediment. The most common instant products are milk powder, soup mixes, baby formula, flavored beverages, coffee powder, cocoa powder, herb extracts, flours, etc. The majority of the instantizers for making the instant products are based on the principle of spray drying, rewetting and agglomeration. Since many products can be instantized by mere agglomeration of spray dried powders, a number of processes have been developed to advance the agglomeration technique. Of the many types of agglomeration techniques, re-wet agglomeration is the most common technique used to make instant products. In this technique, the partially dried product is re-wetted with water or other liquids and allowed to agglomerate.

Some problems associated with the some instantization processes are difficulties in handling and conveying the powdery materials due to the fragile nature of the agglomerate, a relatively high content of fine particles in the final product, and a relatively limited amount of flexibility in varying the particle size and the bulk density of the final agglomerated product. This is especially true in the case of animal feed products, which are packaged and handled in bulk quantities and which can result in the agglomerated particles being crushed and the desirable product properties being compromised.

### SUMMARY

In accordance with one aspect, the present disclosure provides an apparatus for producing an instant product that can readily be dissolved or dispersed or solubilized or reconstituted in a cold or warm liquid. In some embodiments, the product has improved properties including, but not limited to, particle size, wettability, dispersibility, solubility and bulk density. In accordance with another aspect, the present disclosure provides a method of producing an instant product.

In one aspect, the present disclosure provides a method of producing instant products comprising: (a) providing one or more dried base products; (b) rewetting the one or more dried base products in at least two agglomerators to obtain porous random aggregates; and (c) removing excess moisture from the aggregates to obtain a free-flowing instant product. In some embodiments, the size, mixability, and/or wettability of the porous random aggregates obtained from each agglomerator are different. The particle size from each agglomerator can be controlled, for example, by varying the powder feed rate, the orifice/spinner combination, or the heat and/or pressure of the rewetting agent supplied to the hydrating tower.

In one embodiment, the rewetting occurs in four agglomerators. In one embodiment, each agglomerator contains a different orifice/spinner combination. In one embodiment, the dried base product is fed into each agglomerator at the same rate. In another embodiment, the dried base product is fed into each agglomerator at a different rate. In one embodiment, the one or more dried base products added to each agglomerator are the same.

In another embodiment, the one or more dried base products added to each agglomerator are different. The porous random aggregates may be quantified by an index value derived using a weighed inverse equation of the percentage of powder that is captured on 25, 40, 60, 100 and 200 mesh screens.

In one embodiment, the dried base product is a dried powder selected from a group comprising of milk, liquid whey, eggs, liquid animal fats, vegetable oils, lactose, maltodextrin, coffee solution, cocoa solution, fruit juice or concentrate, vegetable juice or concentrate, yeast extract, encapsulated flavor solution, natural or synthetic emulsifiers, wheat and corn starch solution, protein, and mixtures thereof. In one embodiment, the protein is selected from a group consisting of: whole liquid eggs, liquid plasma, hydrolyzed wheat gluten protein, and mixtures thereof.

In an illustrative embodiment, the dried base product comprises liquid whey protein concentrate, liquid animal fat, vegetable oil, and protein that has been spray-dried. In another embodiment, the dried base product comprises milk and eggs. In yet another embodiment, the dried base product comprises milk, hydrolyzed wheat gluten protein, and plasma (e.g. porcine plasma).

In one embodiment, the rewetting agent is selected from the group consisting of: water, emulsifying agents, vegetable or animal fat, and mixtures thereof. In one embodiment, the rewetting agent is a mixture of water and natural and synthetic emulsifying agents. In one embodiment, the rewetting agent comprises lecithin, coconut oil, and water. In one embodiment, the rewetting agent is provided at a temperature from about 120° F. to 130° F.

In one embodiment, the excess moisture is removed by drying the product on a series of fluid beds. In one embodiment, the excess moisture is removed by drying the product on a series of three fluid beds. In one embodiment, the drying temperature of the fluid beds is from about 140° F. to about 250° F.

In one embodiment, the milk replacer is selected from the group comprising calf milk replacer, lamb milk replacer, kid (goat) milk replacer, and piglet milk replacer. In an illustrative embodiment, the milk replacer comprises instantized milk, hydrolyzed wheat gluten protein, and plasma.

In one aspect, the present disclosure provides an apparatus for the manufacture of instant products comprising at least two agglomerators as a component of an instantizer system. In one embodiment, the apparatus comprises four agglomerators. In one embodiment, each agglomerator is fitted with one or more orifice/spinners combinations.

In one aspect, the present disclosure proves a method for improving animal performance, the method comprising: administering to a calf an instantized product, wherein the animal exhibits increased weight gain compared to an animal not administered the instantized product. In one embodiment, the animal is a calf, lamb, goat, or piglet. In some embodiments, the instantized product has a Merick index value of at least 1.4.

In one aspect, the disclosure provides instant products for human and animal consumption including, but not limited to, milk products, nutritional supplements, juice concentrates, milk powder, soup mixes, baby formula, flavored beverages, coffee powder, cocoa powder, herb extracts, flours, milk replacers, etc. In an illustrative embodiment, the instant product obtained by using the present apparatus and process is a milk replacer for animal consumption. In one embodiment, the milk replacer is selected from the group comprising calf milk replacer, lamb milk replacer, kid (goat) milk replacer, and piglet milk replacer.

### BRIEF DESCRIPTION OF THE FIGURES

FIG. 1A and FIG. 1B depict a flow sheet of an illustrative embodiment of the present methods.

### DETAILED DESCRIPTION

In one aspect, the present disclosure provides an apparatus for manufacture of instant products. In another aspect, the apparatus comprises multiple agglomerators as a component of an instantizer system for manufacture of instant products. In one embodiment, the apparatus comprises at least two agglomerators. In other embodiments, the apparatus comprises up to six agglomerators. In some embodiments, the apparatus comprises four agglomerators.

As used herein, the term “agglomerator” is used interchangeably with a “hydrator” or a “hydrator tower”. In a hydrator tower, moisture is added to dry powder ingredients. As these particles fall down through the hydrator tower they stick to each other, forming snowflake-like agglomerates. The wet particles fall onto a conveyor belt, providing time for the water to further soak into the powder particles. The instantizer apparatus of the present invention advantageously allows one to instantize different base products simultaneously and/or vary the agglomeration conditions to achieve a unique particle size distribution in the finished product. Such flexibility cannot be achieved using an instantizer apparatus that includes only one hydrator tower.

The agglomerators can be a part of a single processing line used to manufacture instant products. Each agglomerator can be of various shapes. In some embodiments, each agglomerator has a cone shape structure. In one embodiment each of the agglomerator is provided with a high pressure pump or similar apparatus. In some embodiments, the agglomerator is provided with a high pressure line and fitted with an orifice/spinner combination. Each orifice/spinner combination can be used to produce a different particle size. In one embodiment, the orifice/spinner combinations can be varied in each agglomerator to vary the particle size distribution of the final agglomerated product. In some embodiments, the use of various orifice/spinner combinations in multiple agglomerators leads to the formation of a porous random aggregate with variable particle size. Such an agglomerate with variable particle size possesses improved properties such as, wettability, dispersibility, solubility and bulk density.

In one embodiment, the disclosure provides a method of producing instant products comprising (a) providing a dried base product; (b) rewetting the dried base product by passing them through at least two agglomerators to obtain porous random aggregates; and (c) removing excess moisture from the aggregates to obtain a free-flowing instant product. The dried base product can be obtained commercially or produced by drying a single or combination of liquid base products. Known methods in the art can be used to dry the liquid base product. In one embodiment, two or more liquid ingredients are used to prepared the dried base product. Use of liquid ingredients ensures thorough mixing and distribution of each ingredient throughout the product. In one embodiment, the drying method is selected from spray drying, fluid bed drying, flash drying, spin flash drying, etc. In some embodiments, the dried base product is obtained by using the spray-drying technique. In other embodiments, a food or feed product or a combination of various products, optionally with other additives, is spray dried together to obtain a spray dried base product.

Various food grade additives known in the art can be added to the base product before or after drying. Exemplary additives include flavoring agents, vitamins, minerals, drug products, emulsifiers, foaming agents, gelling agents, stabilizers, suspending agents, thickeners, whipping agents, sweetening agents, enzymes, texturizers, binders, preservatives, defoaming agents, fillers, plasticizers, etc.

In one embodiment, the dried base product is obtained by drying a product selected from the group comprising: milk, liquid whey, liquid animal fats, vegetable oils, coffee solution, cocoa solution, fruit juice or concentrate, vegetable juice or concentrate, yeast extract, encapsulated flavor solution, natural and synthetic emulsifiers, wheat and corn starch solution, various proteins including, but not limited to, whey proteins, eggs, liquid bovine or porcine plasma, biotin, and hydrolyzed wheat, soy or corn gluten protein and other similar products, additives or a mixture thereof. In a suitable embodiment, the dried base product is obtained by drying a combination of wet products or products reconstituted in a liquid. In an illustrative embodiment, the dried base product is obtained by spray-drying a combination comprising products selected from liquid whey protein concentrate, liquid whey, liquid animal fats, vegetable oils, and various proteins including, but not limited to, whole liquid eggs, liquid porcine plasma and hydrolyzed wheat gluten protein. In some embodiments, the combination of two or more dried base products, optionally with other additives listed above, is blended in a blender prior to the rewetting step.

In some embodiments, the dried base product is passed through at least two agglomerators. In other embodiments, the dried base product is passed through up to six agglomerators. In an illustrative embodiment, the dried base product is passed through four agglomerators. In one embodiment, the dried base product is divided into parts and passed through multiple agglomerators to affect rewetting and agglomeration. The dried base product may be fed into the agglomerators at different rates.

The rewetting or rehydration of the powder occurs at the top of the hydrator towers through the use of a high pressure pump and a high pressure line with a orifice/spinner combination atomizing the liquid mixture into a curtain of dried base powder exiting the powder tube. The pressure and the different combination of orifice/spinners can be adjusted based on the product to be instantized. The particular combination of features can be used to manufacture new particle sizes and provides one with the ability to manufacture agglomerates with various genometric shapes and sizes.

In some embodiments, the rewetting agent is selected from the group comprising water, natural and synthetic emulsifiers, vegetable oils or animal fats, or a mixture thereof. In an illustrative embodiment, the liquid system used in the rewetting process consists of a mixture of water and natural and synthetic emulsifying agents. In one embodiment, the rewetting agent is a mixture of water, lecithin, and coconut oil. In an illustrative embodiment, the water and emulsifying agent or agents are mixed and stored in a heated container and introduced to the high pressure pump at a temperature not less than about 120° F. In some embodiments, the rewetting liquid is sprayed under pressure onto a curtain of dried base powder. The amount of the emulsifying agent, such as lecithin may affect the wettability of the finished product. Generally, lecithin can improve the wetting of the product wets upon mixing.

In one embodiment, the dried base product is divided into parts and passed through multiple agglomerators. In one embodiment, the rewetted product in each agglomerator is agglomerated to form the random porous aggregates and makes a chemical change. In some embodiments, a seed crystal can be used to enhance the particle size of the porous aggregates. In one embodiment, the seed material is selected from simple and complex sugars. In one embodiments, the seed material is simple sugar crystals, such as lactose. The presence of lactose, maltodextrin, and/or other disaccharides in the dried base product can increase the particle size of the resulting agglomerate.

In some embodiments, the rewetted product is collected on a timing belt. For example, the rewetted product is allowed to fall through the hydrator tower under gravity onto the timing belt. The timing belt offers the capability to adjust retention time on the belt for each product produced by the process. In some embodiments, dehumidified air is passed to dry the product on the timing belt. In other embodiments, the rewetted product is further dried on a fluid bed system. The fluid bed system comprises single or multiple stages maintained at same or different temperature. Each of the fluid bed stages can be operated at a temperature selected from about 40° F. to about 290° F. In one embodiment, the fluid bed stages are operated at a temperature selected from about 140° F. to about 250° F. In an exemplary embodiment, the first two fluid beds have four stages for individual control of the drying air temperature. The four stages are operated at a drying temperature of about 225° F., about 210° F., about 160° F. and about 60° F.

### Instantized Products

In one embodiment, the disclosure provides instant products for human and animal consumption including, but not limited to, milk products, nutritional supplements, juice concentrates, milk powder, soup mixes, baby formula, flavored beverages, coffee powder, cocoa powder, herb extracts, flours, milk replacers, etc. In an illustrative embodiment, the instant product obtained by using the present apparatus and process is a milk replacer for animal consumption.

In one embodiment, the various combinations of multiple hydrators on a single processing line to manufacture instant products results in the formation of a product having varying particle size which possesses improved wettability, dispersibility and solubility characteristics. In one embodiment, the present apparatus and methods produce products having a low level of fine material. In other embodiments, the present apparatus and methods facilitate control of particle size and/or the bulk density of the product. In other embodiments, the present apparatus and methods eliminate the need for a large amount of powdered feed material in agglomeration processes. These advantages can be specifically expanded to include all baby animal feeds considering the method by which they are handled, as compared to a human food products. For example, baby animal feed products are handled completely different from human products which are usually packaged in very small quantities of 2-3 pounds. Baby animal feeds are packaged in about 50 pound to about 1,000 pound containers. Therefore, the stress on the porous random aggregates is greatly multiplied. Baby animal feeds produced by this method therefore demonstrate a multifold advantage over those produced by other methods or even over human food products.

In one embodiment, the product obtained can readily be dissolved or dispersed or solubilized or reconstituted in a cold or warm liquid. In some embodiments, the reconstituting liquid is water. In some embodiments, the final product possesses improved properties including, but not limited to, particle size, wettability, mixability, dispersibility, solubility and bulk density.

As used herein, “wettable” or “wettability” refers to the ability of a powder to break water tension, or drops below the surface of the water. Wettability is determined by thermodynamic properties, such as surface energy and surface tension. For example, wettability may be determined by placing approximately 30 g of a powder on the surface of 200 mL of water at 72° F. contained in a 600 mL beaker, and noting the length of time required for the product to completely wet and sink spontaneously below the surface of the water. As used herein, the terms “mixable” or “mixability” refers to the ability of a slurry to become substantially homogeneous under the action of the agitation system to which it is subjected.

In an illustrative embodiment, the instantized product is an animal milk replacer. The purpose of milk replacers for pre-weaned animals is to take the place of whole milk when whole milk is not available or not economically fed. Typically, milk replacers should contain at least 20 percent protein and at least 10 percent fat. These ingredients can be derived from a variety of sources as detailed below.

Protein. A typical replacer protein level is 10 to 30 percent. The most common levels used by calf raisers are 20 to 22 percent. Higher protein levels are usually reserved for intensive milk replacer feeding programs designed to increase growth rate. With these programs, the increase in protein percentage coincides with an increase in milk replacer feeding rate and a decrease in milk replacer fat percentage. Milk proteins are typically more highly digestible than non-milk proteins and provide a desirable amino acid profile for growth. Many different milk products are used in manufacturing milk replacers. These include whey, whey protein concentrate, delactosed whey, skim milk, and casein. Whey products are currently utilized as principal protein sources in milk replacers. Protein sources are typically the most expensive milk replacer ingredients.

Egg proteins have been incorporated into commercial milk replacers for several years with excellent results. Egg proteins are also less expensive than milk proteins, thereby reducing the cost of milk replacer. Eggs can also be utilized as a source of energy (eggs are 37% fat), iron, phosphorous, trace minerals and vitamins. They are an important source of lecithin (about 8-9% lecithin in egg yolk). Lecithin acts as a natural antioxidant as well as a skin and hair conditioner, and is a source of choline which is associated with positive hair coat characteristics.

Animal plasma proteins provide a unique protein source that contains active albumin and globulin proteins such as IgG and IgM. This highly soluble, high quality protein source has an amino acid profile and nutritive value comparable to nonfat dried (skim) milk and casein. In the digestive tract, IgG has a direct effect on pathogens and may also have a direct effect on the intestinal lining, or mucosa. Animal plasma is obtained by centrifuging whole blood into its major components, plasma and blood cells. The two main types of animal plasma are bovine (ruminant) and porcine (swine).

Wheat protein isolate provides a high quality, economical protein source. Wheat protein isolate is manufactured from wheat flour by separating the gluten protein from wheat starch. This protein is then enzymatically hydrolyzed and transformed to small proteins and peptides before drying. Wheat protein isolate is suited for incorporation into calf milk replacers. It is low in fiber and ash and contains a much higher percentage of protein compared to whey protein concentrate (80% protein vs. 34% protein). With the addition of various synthetic amino acids, digestibility of wheat protein isolate dry matter, organic matter and crude protein is very high and is estimated to be 95%. It is also free from anti-nutritional factors such as those common to soy proteins that are known to reduce animal performance.

Soy proteins can provide an economic alternative to milk proteins. The popularity of soy proteins stems from their widespread availability, relatively low cost and generally favorable amino acid profile. These vegetable proteins can be substituted for a portion of the milk proteins in milk replacers, providing acceptable calf growth and performance. Soy proteins should be avoided when raising calves on an intensive milk replacer feeding program.

Fats and Oils. Fats and oils provide a concentrated energy source for animal feeds. Fat levels in milk replacers typically range from 10 to 24 percent with 15 to 20 percent being the most common. Higher fat milk replacers are often selected for cold climates while low fat formulas are more often used in hot climates and in formulations designed for intensive milk replacer feeding programs. Lard and choice white grease are of porcine origin and are exemplary animal fats. Excellent performing milk replacers can be made using vegetable oils exclusively such as soy, palm and coconut oil. However, they are substantially more expensive to use than animal fats.

Carbohydrates. Carbohydrates also supply energy in milk replacers. Lactose is a carbohydrate and is a major energy source in milk replacers. Lactose is a natural component of whey and whey protein concentrate and has about 40% the energy value of fat. A typical milk replacer formulation contains about 40-45% lactose. Since fat is typically 15-20% of the formula, lactose and fat are the major energy sources in milk replacers.

Vitamins and Minerals. In one embodiment, one or more minerals are added to the base product. Minerals are important for the structural development of the young animals, such as calves. They are an important part of body fluids, playing a critical role in maintaining acid-base balance and nerve transmission. Milk replacers may be fortified with one or more of the following minerals: calcium, chlorine, cobalt, copper, iodine, iron, magnesium, manganese, phosphorus, potassium, selenium, sulfur, and zinc.

In one embodiment, one or more vitamins are added to the base product. Vitamins play an important role in metabolism and are involved in enzyme systems. The young calf, with its limited storage of vitamins, is dependent on dietary sources of these essential nutrients. Milk replacers may be supplemented with the following vitamins: vitamin A, vitamin D, vitamin E, vitamin B12, thiamine (vitamin B1), vitamin C, biotin, choline, folic acid, pyridoxine (vitamin B6), vitamin K, riboflavin (vitamin B2), niacin, and pantothenic acid.

In one embodiment, organic acids can be added to milk replacers. Lowering the pH of milk replacers helps them stay fresher longer when reconstituted. A lower pH in the upper digestive tract may enhance the growth of beneficial bacteria and suppress the growth of pathogenic bacteria.

### Merrick Index

In one embodiment, the porous random aggregates are quantified in terms of their variable particle size using a weighed inverse equation. For the measurement, a known quantity of finished product, e.g., 100 g, is passed through an agitating screen having variable mesh sizes, such as 25, 40, 60, 100, and 200 mesh. The powder falling through the 100 mesh is considered to be powder being held on 200 mesh screen and so on. Thus, for 100 grams of finished product, the equation used to calculate the index number on a size 25 mesh is represented as:

$$\frac{Grams of product on 25 mesh ( A )}{25} = \frac{A}{25} = 0.04 A$$

Using similar equations, the index numbers for each mesh size used can be calculated. Thus, for A, B, C, D and E grams of product respectively held on 25, 40, 60, 100 and 200 mesh, the individual numbers would be 25 mesh=0.04A, 40 mesh=0.025B, 60 mesh=0.0167C, 100 mesh=0.01D and 200 mesh=0.005E. The resulting individual numbers are added to arrive at the Merrick index number. Based on the experimental models, relative index numbers have been seen to vary from a low of 1.15 to a maximum to date of 2.5. In some embodiments, the instantized product has a Merrick Index of at least 1.2, at least 1.3, at least 1.4, at least 1.5, at least 1.6, at least 1.7, at least 1.8, at least 1.9, or at least 2.0.

This Merrick index number is unique since it provides proper recognition of the percentage of the powder that is captured on various mesh screens. All the different particles sizes can be compared with a single Merrick index number. The Merrick index number can be used to quantify the amount of porous random aggregates in a product sample. For example, if a finished product has an index number of 2.05 and the same product when quantified using a flow agent gives a relative index number of 1.27, then the difference is considered to represent the amount of porous random aggregates. The percentage of porous random aggregates destroyed by the use of flow agents can be calculated as [(2.05−1.27)/2.05]×100=38%. This value is known as the Merrick index value. This example demonstrates that the use of a flow agent in the determination of particle size will result in a significant destruction of the porous random aggregates. This equation can be used to compare the quantities of porous aggregates in two or more samples.

### EXAMPLES

The present invention, thus generally described, will be understood more readily by reference to the following examples, which are provided by way of illustration and are not intended to be limiting of the present invention.

### Example 1

### Production of Instantized Baby Animal Milk Replacer

A combination of liquid whey protein concentrate, liquid whey, liquid animal fats, vegetable oils and various proteins including, but not limited to, whole liquid eggs, liquid porcine plasma and hydrolyzed wheat gluten protein is blended in a blender and spray dried to from a base. The spray-dried base is fed via a powder tube to four agglomerators. A mixture of water and natural and synthetic emulsifying agents maintained at not less than 120° F. is sprayed in each agglomerator using a high pressure pump and variable orifice/spinner combinations at desired pressure, e.g., 2500 psi. The liquid mixture is atomized into a curtain of dried base powder and the product is rewetted and agglomerated. Lactose sugar crystals are added as seed material to enhance the size of the porous random aggregates. The product is allowed to fall under the influence of gravity through the agglomerator and on to a timing belt where dehumidified air is passed to dry the product. The product is dried on four fluid beds maintained at variable temperatures of 225° F., 210° F., 160° F. and 60° F. to remove excess moisture. The resultant product is passed through a sifter and optionally blended with additives before being packaged for distribution.

### Example 2

### Production of Instantized Calf Milk Replacers

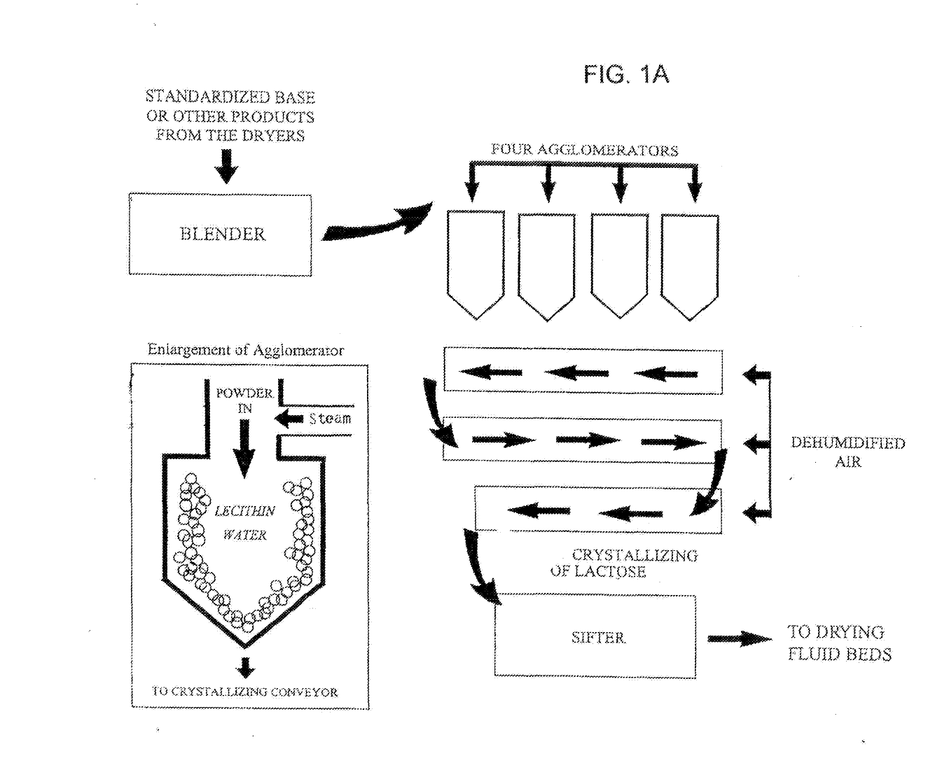

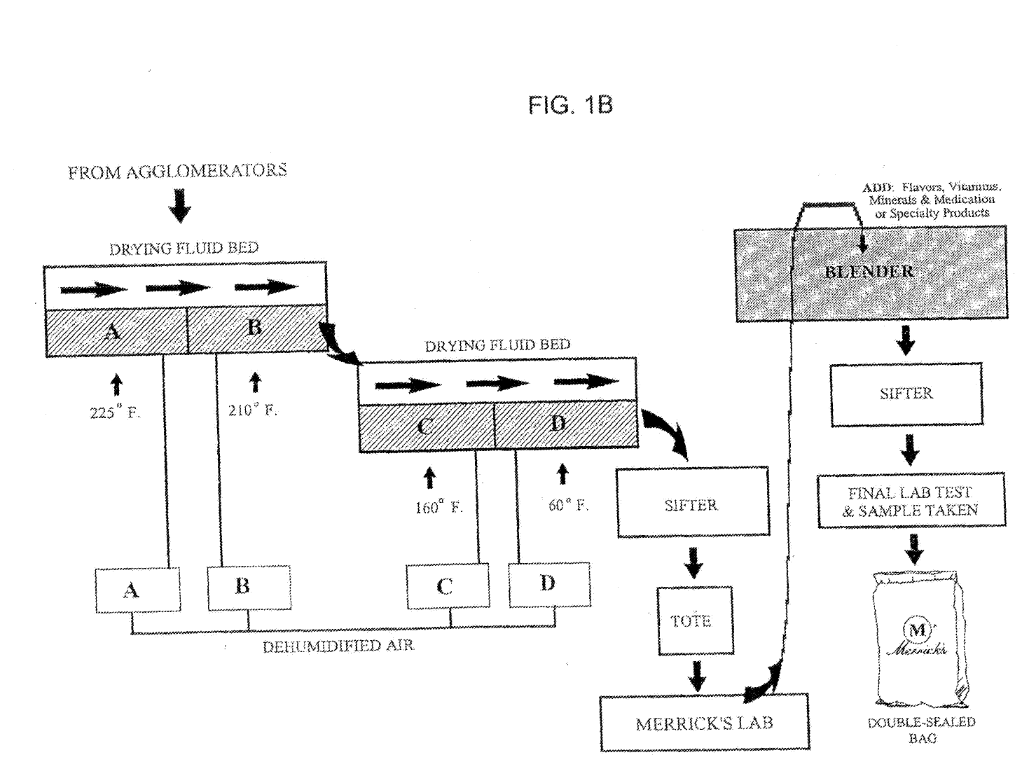

In this example, two calf instant milk replacer product was prepared. The procedure was generally as illustrated in FIG. 1. The dried based product comprised either (1) milk, wheat, and plasma (20% protein, 29% fat) or (2) all milk proteins (20% protein, 29% fat). The dried based products were spray dried and had a total moisture content of about 3%.

These powders were fed at a metered rate to four agglomerating chambers as shown in FIG. 1. The dried base product was re-wetted with water, lecithin, and coconut oil. The rewetting agent was pumped to the atomizing nozzle at a pressure of approximately 2500 psi at a temperature of approximately 120-130° F. The amount of rewetting agent added was sufficient to control the moisture level of the aggregates leaving the agglomerating chamber at a total moisture level of about 7%. The moist agglomerated material was then dried to a moisture content below 2% on four fluid bed dryers.

### Example 3

### Calculation of Porous Random Aggregates for Two Samples

The porous random aggregates of the milk replacer prepared in Example 2 were analyzed using the Merrick Index described above. One hundred (100) g of sample of product prepared by the process above was passed through various mesh sizes of 25, 40, 60, 100 and 200. Approximately 5 g of sample is held on 25 mesh, 10 g on 40 mesh, 30 g on 60 mesh, 40 g on 100 mesh and 15 g on 200 mesh. For a total sample weight of 100 grams; then weight amount of powder on each mesh is divided by mesh size and the total is added to arrive at the Merrick index number for the sample. Thus, for the above sample, the Merrick index number is

$$\frac{5}{25} + \frac{10}{40} + \frac{30}{60} + \frac{40}{100} + \frac{15}{200} = 1.425$$

Similarly, the Merrick index was calculated using a non-instantized product and added to arrive at the Merrick Index number of 1.01. Thus, comparing the two index numbers, it can be it can be concluded that the particle size improvement using the current process was 41.5%. This is the Merrick index value, which represents the actual size and measurement of the porous random aggregate. These results indicate that the methods described herein are useful for the production of instant product with improved particle size, solubility, wettability and bulk density.

### Example 4

### Comparison of Instantized Vs. Non-Instantized Calf Milk Replacer on Calf Performance

This examples describes a trial of the performance of calves fed instantized or non-instantized milk replacer. Calves received the instant milk replacers prepared as described in Example 3 or a milk replacer comprising the same dried base, but which was not instantized. Calves were purchased from sale barn and were housed in individual hutches. Calves were fed 1 lb/calf/day instantized milk replacer powder or control powder. Calves were given free choice water throughout the trial. Calves were weaned at 42 days and when they consumed 1 lb of starter for 3 consecutive days.

The data are summarized in Table 1. When compared to control calves, the calves that were fed the instantized milk replacer were 17.8% heavier at the end of the trial. The calves ate 14.1% more starter and required 27% fewer medical treatments during the trial compared to control calves. Thus, the instantized milk replacer resulted in the higher weight gain and starter intake and the fewest medical treatments. The data show that using instantized calf milk replacer that is produced in accordance with the present invention improves both growth performance and health status of calves.

TABLE 1
Comparison of Instantized Milk Replacer and Control

| | Difference Between Instantized and |
|---|---|
| | Non-Instantized Calf Milk Replacer |
| Average Total Gain, lb | 17.8% |
| Average Starter Intake, lb | 14.1% |
| Number of Calves Requiring | −27.3% |
| Medical Treatment | |
| Medical Treatment Days | −14.3% |

The present disclosure is not to be limited in terms of the particular embodiments described in this application, which are intended as illustrations of individual aspects thereof. Many modifications and variations can be made without departing from its spirit and scope, as will be apparent to those skilled in the art. Functionally equivalent embodiments within the scope of the disclosure, in addition to those enumerated herein, will be apparent to those skilled in the art from the foregoing descriptions. Such modifications and variations are intended to fall within the scope of the claims, along with the full scope of equivalents to which such claims are entitled. It is to be understood that this disclosure is not limited to particular methods, reagents, compounds or compositions, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 units refers to groups having 1, 2, or 3 units. Similarly, a group having 1-5 units refers to groups having 1, 2, 3, 4, or 5 units, and so forth.

The various aspects and embodiments disclosed herein are for purposes of illustration and are not intended to be limiting, with the true scope and spirit being indicated by the following claims.

What is claimed is:

1. A method of producing instant products comprising:
(a) providing one or more dried base products;
(b) rewetting the one or more dried base products in at least two agglomerators to obtain porous random aggregates; and
(c) removing excess moisture from the aggregates to obtain a free-flowing instant product.

2. The method of claim 1, wherein the rewetting occurs in four agglomerators.

3. The method of claim 3, wherein each agglomerator contains a different orifice/spinner combination.

4. The method of claim 1, wherein the dried base product is fed into each agglomerator at the same or different rate.

5. The method of claim 1, wherein the one or more dried base products added to each agglomerator are the same or different.

6. The method of claim 1, wherein the dried base product is a dried powder selected from a group comprising of milk, liquid whey, eggs, liquid animal fats, vegetable oils, lactose, maltodextrin, coffee solution, cocoa solution, fruit juice or concentrate, vegetable juice or concentrate, yeast extract, encapsulated flavor solution, natural or synthetic emulsifiers, wheat and corn starch solution, protein, and mixtures thereof.

7. The method of claim 1, wherein the rewetting agent is selected from the group consisting of: water, emulsifying agents, vegetable or animal fat, and mixtures thereof.

8. The method of claim 1, wherein the rewetting agent is provided at a temperature from about 120° F. to 130° F.

9. The method of claim 1, wherein excess moisture is removed by drying the product on a series of fluid beds.

10. The method of claim 9, wherein the drying temperature of the fluid beds is from about 140° F. to about 250° F.

11. A baby animal milk replacer produced by the method of claim 1, wherein the milk replacer has a Merrick index of at least 1.4.

12. The milk replacer of claim 11, selected from the group comprising calf milk replacer, lamb milk replacer, kid (goat) milk replacer, and piglet milk replacer.

13. The milk replacer of claim 12, comprising instantized milk, hydrolyzed wheat gluten protein, and plasma.

14. An apparatus for manufacture of instant products comprising at least two agglomerators as a component of an instantizer system.

15. The apparatus of claim 14, comprising four agglomerators.

16. The apparatus of claim 14, wherein each agglomerator is fitted with one or more orifice/spinners combinations.

17. The apparatus of claim 16, wherein each agglomerator contains a different orifice/spinner combination.

18. A method for improving animal performance, the method comprising: administering to a calf an instantized product a Merrick index of at least 1.4, wherein the animal exhibits increased weight gain compared to an animal not administered the instantized product.

19. The method of claim 18, wherein the animal is a calf, lamb, goat, or piglet.

20. The method of claim 18, wherein the instantized product comprises milk, hydrolyzed wheat gluten protein, and plasma.
